(19) United States
(12) Patent Application Publication
(10) Pub. No.: US 2010/0231952 A1
(43) Pub. Date: Sep. 16, 2010

(54) Printing system and method

(76) Inventors: Fabio Giannetti, Los Gatos, CA (US); Shaun Henry, Middleton, ID (US); Matthew Cooley, Eagle, ID (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/403,134

(22) Filed: Mar. 12, 2009

(51) Int. Cl. G06F 3/12

(52) U.S. Cl. 358/1.15

(57) ABSTRACT

A printing method and system include identifying a reusable object in a print job. If the reusable object has been previously RiPped and cached, then the RiPped object is loaded for printing. If the reusable object has not been RiPped and cached, then the object is RiPped, cached and loaded for printing.

### BACKGROUND

Digital printing processes include the transmission or transport of digital data representative of a document to be printed to a digital printer, which takes the document data and produces a hard copy, printed, version of the document. Document data can be conveyed to the printer, for example, by the use of a printer language. The document data are converted into the appropriate printer language, typically by the software application used to generate the original document. The printer language then instructs the printer to create a rasterized image. Rasterization is a process of converting the data that describes the text and graphics into the format that is required by a printer's “print engine,” which is the machinery that actually puts the marks onto the page. Rasterization is performed by a raster image processor, often referred to as a “RIP,” and thus, the rasterization process is often referred to as “RIPping.”

With some systems, the RIP is a computer that is integral to the printer itself. Desktop printers, such as laser or inkjet printers, will typically have an integral RIP within the printer. With other systems, for example, larger commercial printers, the RIP is separate from the printer. In this case, the RIP is implemented in software that runs on a computer separate from, but connected to, the printer. In commercial applications, the RiPping process can be very resource intensive. High-volume print jobs can easily contain tens of thousands of pages that all have to be RiPped, requiring extensive amounts of processing power and memory space. Thus, the RiPping process often creates troublesome bottle necks in the overall printing process.

For these and other reasons, a need exists for the present invention.

### BRIEF DESCRIPTION OF THE DRAWINGS

FIG. 1 is a block diagram conceptually illustrating an embodiment of a printer system.

FIG. 2 is a flow diagram illustrating an embodiment of a printing method.

FIG. 3 is a block diagram illustrating further aspects of the system and method of FIGS. 1 and 2.

FIG. 4 is a block diagram illustrating further aspects of the system and method of FIGS. 1 and 2.

### DETAILED DESCRIPTION

In the following detailed description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

In the following disclosure, specific details may be set forth in order to provide a thorough understanding of the disclosed systems and methods. It should be understood however, that all of these specific details may not be required in every implementation. In other instances, well-known methods, procedures, components, circuits, and networks have not been described in detail so as not to unnecessarily obscure the disclosed systems and methods.

It will also be understood that, although the terms first, second, etc. are used herein to describe various elements, these elements should not be limited by these terms. These terms are only used to distinguish one element from another.

FIG. 1 conceptually illustrates portions of an embodiment of a printer system 10. The printer system 10 includes a print engine 12, a raster image processor (RIP) 14 and a cache memory 16. In general, embodiments of the system 10 are configured such that reusable, previously RiPped objects are stored in the cache 16, which could include shared file systems or databases. The RIP 14 is provided with the location of previously-RiPped objects for inclusion in a RIP job. Further, a print job can be analyzed before it is RiPped to identify objects within a job that may be reusable. In addition to detecting objects that are reusable within a job, objects in a job that may be reusable outside of that job and also identified. Once these identified objects are RiPped, they can be saved in the cache 16 for use in other print jobs. Previously, even though multiple print jobs often contained the same objects, these objects had to be RiPped on a per job basis, resulting in slower RiPping times and thus a lower quantity of printed pages.

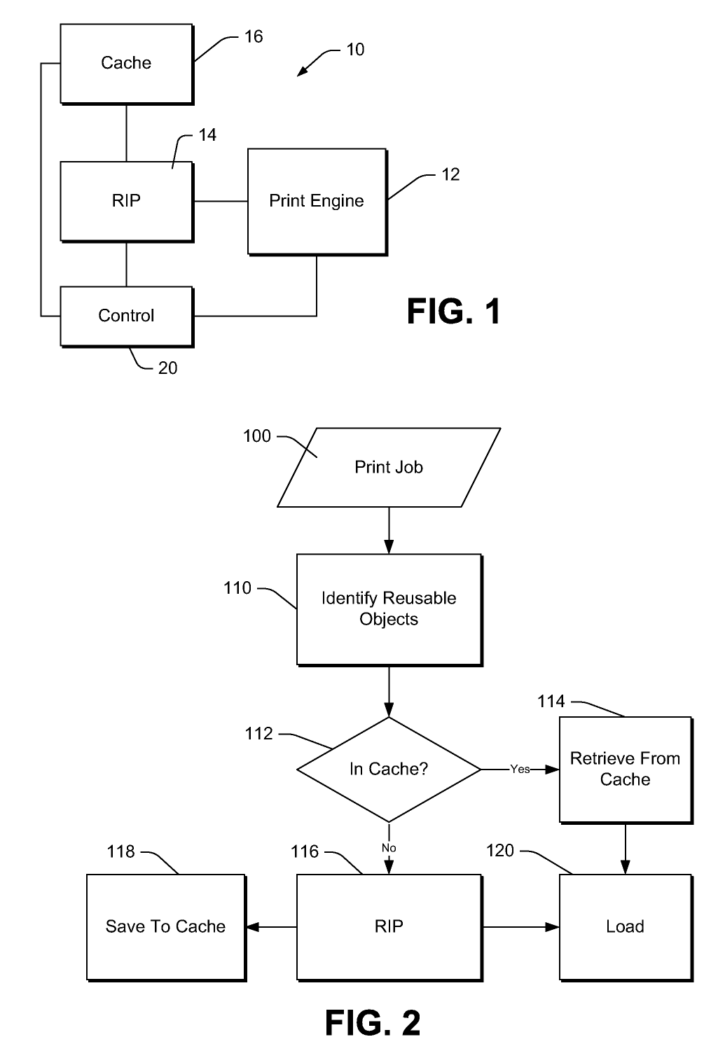

FIG. 2 illustrates an embodiment of a printing method implemented with the printing system 10. In block 110, a print job 100 is analyzed to identify objects in the print job that are reusable outside the print job. In block 112, if the reusable objects have been previously cached, they are retrieved from the cache 16 in block 114 and loaded to the print engine 12 for printing in block 120. If it is determined that a reusable object has not been previously cached in block 112, the object is RiPped in block 116 and then loaded to the print engine 12 for printing in block 120. The RiPped object is also saved to the cache 16 in block 118 so that it can be used within the current print job, or by other print jobs.

In some embodiments, the process illustrated in FIG. 2 is implemented by a control module 20 that is integral to the print engine 12 or configured in an external computer. In some embodiments, the control module 20 is configured to analyze the job page description language (PDL) prior to the job being RiPped, and detects the internal job objects (such as images, fonts, text, backgrounds, etc.) that are candidates for reuse either within that particular job, or across multiple jobs. In contrast, with previously known systems reusable objects such as fonts, logos, signatures, diagrams, images, etc. have been limited to reuse in the same document, for instance, on multiple pages within a single print job.

The control module 20 generates a lookup ID for a reusable object within a job and determines whether the object is reusable within that job or across jobs. A hash, CRC or other suitable algorithm can be used to identify objects and determine their reusability status. Additional information regarding the reusable object is also identified, such as the location of the object within the print job.

An object that is reusable is often referred to as a resource. Certain printer languages facilitate identifying which resources are needed at a particular point in a print job. This allows a resource to be rasterized once and used many times, instead of being rasterized on each page and/or each print job in which it is used. An example of a print language for use with reusable content is personalized print mark-up language (PPML). PPML itself only defines how existing resources are combined to create pages, documents and jobs. For example, PPML defines where on a page a graphic object is to appear and the space into which it must fit. However, the attributes of the resources themselves are defined by further documents, or files, expressed in existing mark-up languages, such as Extensible Style Sheet Language Format Objects (XSL-FO), to which the PPML document refers.

Once the RIP 14 renders an object that has been determined to be reusable (either within the job or across multiple jobs), the RiPped object is saved to the cache 16 and assigned a lookup ID. In various embodiments the cache 16 can be implemented on a local file system, a remote file system, in a database, RAM or any other suitable data storage mechanism. When the RIP 14 processes the job and encounters an object that has been tagged as a previously RiPped asset, the RIP 16 simply inserts the previously rendered object data into the data output stream rather than re-RiPping the asset. This leads to a significant performance improvement, because for many jobs (such as photo, marketing collateral and other image intensive applications), the RiPping process is computer bound due to the nature of the complex assets.

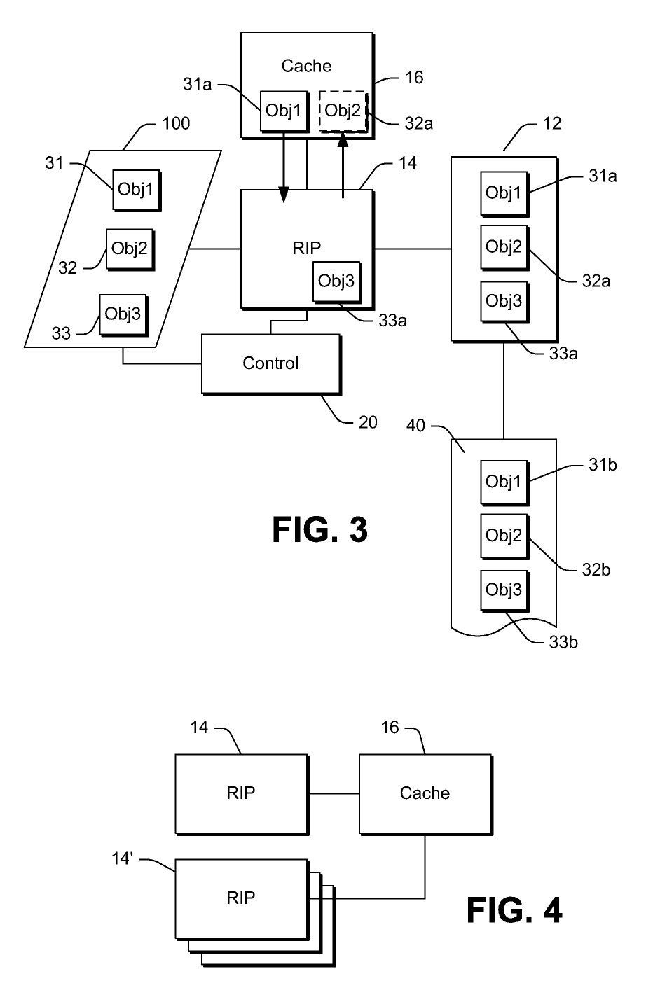

FIG. 3 illustrates further aspects of an embodiment of the disclosed printing process. The control module 20 analyzes the print job 100 and identifies first, second and third reusable objects 31, 32, 33 (block 110 of FIG. 2). The control module 20 determines that the first object 31 was RiPped in a previous print job and the rasterized version 31a was saved to the cache 16. For example, a lookup ID may have been assigned to the first object 31 to facilitate locating it in the cache 16. In accordance with block 114 of FIG. 2, the RiPped first object 31a is retrieved from the cache 16 by the RIP 14, rather than RIPping the first object 31 again. The rasterized first object 31a is also output to the print engine 12.

In some embodiments, the cache 16 serves as a centralized cache so that multiple RIPs can access and write to the centralized cache. FIG. 4 illustrates aspects of such an embodiment. In addition to the RIP 14 being connected to the cache 16, one or more additional RIPs 14′ are also connected to the cache 16. Such an arrangement facilitates the use of reusable objects across print jobs, where a reusable object from one job can be RiPped by the RIP 14 and saved to the cache 16, then reused for another print job by another RIP 14′. In some embodiments, each RIP is controlled by a respective control module, and in other embodiments a common control module controls multiple RIPs.

Referring back to FIG. 3, the control module 20 further determined that the second object 32 has not been previously RiPped. Thus, as noted in block 116 of FIG. 2, the controller 20 instructs the RIP 14 to rasterize the second object 32, save the rasterized version 32a to the cache 16, and also output it to the print engine 12. The third reusable object 33 was not RiPped and saved to the cache 16 in a previous job, but was RiPped for an earlier part of the current print job 100. Thus, the rasterized version 33a exists in the memory of the RIP 14. Rather than RiPping the third object 33 again, the previously RiPped object 33a is output to the print engine 12. Depending on the analysis by the control module 20, the rasterized third object 33a may also be saved to the cache 16.

The rasterized first, second and third objects 31a, 32a, 33a are then further processed by the print engine 12, resulting in the printed version 40 including the printed first, second and third objects 31b, 32b, 33b.

Having prior knowledge of where these reusable objects are located within a job and storing them in the cache 16 externally to the RIP 14 insures that after a job is profiled, the system can be re-configured to a state where the job is RiPped in the fastest time possible because the previously RiPped assets can be loaded into the RIP 14 prior to the job being processed. This is possible because the control module 20 has identified which reusable objects are required in every job or job portion and can instruct the RIP 14 to load the previously saved RiPped images from a certain location.

In this manner, print jobs can be reused once they have been RiPped. The control module 20 has a global view of the reusable objects within the job so it can instruct the RIP 14 to preserve in memory and/or save these reusable objects in a specific location (export) or database. When a second portion of the same job or a new job instance based on the same template is created, the RIP 14 will avoid re-RiPping these assets and complete the job faster.

Moreover, the control module 20 can instruct the RIP 14 to load the previously cached RiPped assets in order to prepare the system to receive a job or a family of related jobs. RiPped assets could be stored in a database with an algorithmically determined key for subsequent retrieval. This extends the single RIP cache management to a system level cache management.

Once a job or job portion is processed, it is routed to the RIP 14 that has the required RiPped assets, reducing the RiPping time. The overall job management for the RiPping stage is now improved since the control module 20 knows the job requirements, the available RiPped objects and each individual RIP status regarding reusable objects that have already been loaded in a RIP. This enables a best fit strategy between the RiPs and the job requirements. Whenever these requirements are not met, the control module 20 can change the RIP cache by instructing the RIP to load assets from known locations. Once an object is RiPped in a particular RIP, that object can be used by all other RiPs without extra computational cost.

In some embodiments, the RIP 14 provides an application programming interface (API) for read-only (RO) cache management with single RO level operations to preserve objects in cache, save to location, load from location, remove from cache, give list of all the RO present in cache, etc.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A printing method, comprising:
identifying a reusable object in a print job;
if the reusable object has been previously identified, RiPped and cached, then loading the RiPped object for printing; and
if the reusable object has not been RiPped and cached, then RiPping the object, caching the RiPped object, and loading the RiPped object for printing.

2. The method of claim 1, further comprising:
determining whether a reusable object is reusable within the print job.

3. The method of claim 1, further comprising:
determining whether a reusable object is reusable across print jobs

4. The method of claim 1, further comprising:
generating a lookup ID for the identified reusable object.

5. The method of claim 1, wherein identifying the object includes identifying a location of the object within the print job.

6. The method of claim 1, wherein identifying the object includes analyzing a page description language (PDL) of the print job.

7. The method of claim 1, wherein loading the RiPped object for printing includes instructing a raster image processor (RIP).

8. The method of claim 1, further comprising printing the print job.

9. The method of claim 1, wherein identifying the reusable object in a print job includes identifying the reusable object in a first print job, and wherein the previously RiPped and cached object was previously identified in a second print job.

10. A printing system, comprising:
a raster image processor (RIP);
a print engine coupled to the RIP;
a cache accessible by the RIP; and
a control module configured to
identify a reusable object in a print job;
if the object has been previously identified, RiPped and stored in the cache, then instructing the RIP to retrieve the RiPped object from the cache and output the RiPped object to the print engine; and
if the object has not been previously identified, RiPped and stored in the cache, then instructing the RIP to RIP the object, save the RiPped object to the cache, and output the RiPped object to the print engine.

11. The system of claim 10, wherein the control module is configured to determine whether a reusable object is reusable within the print job.

12. The system of claim 10, wherein the control module is configured to determine whether a reusable object is reusable across print jobs

13. The system of claim 10, wherein the cache is a storage device external to the RIP.

14. The system of claim 10, wherein the cache is an internal memory of the RIP.

15. The system of claim 10, wherein the control module is configured to generate a lookup ID for the identified reusable object.

16. The system of claim 10, wherein the control module is configured to identify a location of the object within the print job.

17. The system of claim 10, wherein the RIP comprises a plurality of RIPs, wherein the cache is accessible by each of the RIPs.

18. A printing system, comprising:
a raster image processor (RIP);
a cache accessible by each of the RIPs;
a control module configured to
identify a reusable object in a first print job;
instruct the RIP to RIP the object and save the RiPped object to the cache;
identify the reusable object in a second print job; and
instruct the RIP to retrieve the RiPped object from the cache.

19. The printing system of claim 18, wherein the RIP includes first and second RIPs, and wherein the control module is configured to
instruct the first RIP to RIP the object and save the RiPped object to the cache; and
instruct the second RIP to retrieve the RiPped object from the cache.

20. The printing system of claim 18, wherein:
the RIP includes first and second RIPs;
the control module includes first and second control modules corresponding to the first and second RIPs;
the first control module is configured to instruct the first RIP to RIP the object and save the RiPped object to the cache; and
the second control module is configured to instruct the second RIP to retrieve the RiPped object from the cache.
